(19) United States
(12) Patent Application Publication
(10) Pub. No.: US 2026/0330316 A1
(43) Pub. Date: Oct. 22, 2026

(54) TRAINING DEVICE, TRAINING METHOD, AND RECORDING MEDIUM

(71) Applicant: NEC Corporation, Tokyo (JP)

(72) Inventors: Taiki MIYAGAWA, Tokyo (JP); Akito NARAHARA, Tokyo (JP); Akinori EBIHARA, Tokyo (JP)

(73) Assignee: NEC Corporation, Tokyo (JP)

(21) Appl. No.: 19/646,707

(22) Filed: Apr. 14, 2026

(30) Foreign Application Priority Data
Apr. 21, 2025 (JP) 2025-069673

(51) Int. Cl. G06N 20/00; G06F 18/24

(52) U.S. Cl. CPC G06N 20/00; G06F 18/24

(57) ABSTRACT

In the training device, the estimator sequentially acquires a plurality of elements included in series data and estimates a score of the series data for a plurality of classes of classification. The classifier classifies the series data into any of the plurality of classes based on the score. The loss calculation unit calculates a loss using a loss function based on correctness of a classification result of the series data and time required for classification. The training unit trains the classifier based on the loss.

### INCORPORATION BY REFERENCE

This application is based upon and claims the benefit of priority from Japanese Patent Application 2025-069673, filed on Apr. 21, 2025, the disclosure of which is incorporated herein in its entirety by reference.

### TECHNICAL FIELD

The present disclosure relates to classification of series data.

### BACKGROUND ART

A method of classifying series data using a machine learning model is known. For example, JP2024-124866A discloses a method of determining whether an operation pattern indicated by a time-series image is normal or abnormal using a machine learning model.

### SUMMARY

In a case where series data is classified using a machine learning model, it is desirable to obtain an accurate classification result in an early stage as much as possible of the input series data.

An object of the present disclosure is to provide a machine learning model capable of obtaining an accurate classification result at an early stage of the input series data.

According to an example aspect of the present invention, there is provided a training device comprising:
an estimator that sequentially acquires a plurality of elements included in series data and estimates a score of the series data for a plurality of classes of classification;
a classifier that classifies the series data into any of the plurality of classes based on the score;
a loss calculation means for calculating a loss using a loss function based on correctness of a classification result of the series data and time required for the classification; and
a training means for training the classifier based on the loss.

According to another example aspect of the present invention, there is provided a training method executed by a computer, the method comprising:
sequentially acquiring a plurality of elements included in series data, and estimating a score of the series data for a plurality of classes of classification using an estimator;
classifying the series data into any of the plurality of classes based on the score using a classifier;
calculating a loss using a loss function based on correctness of a classification result of the series data and time required for the classification; and
training the classifier based on the loss.

According to still another example aspect of the present invention, there is provided a program that causes a computer to execute processing of:
sequentially acquiring a plurality of elements included in series data, and estimating a score of the series data for a plurality of classes of classification using an estimator;
classifying the series data into any of the plurality of classes based on the score using a classifier;
calculating a loss using a loss function based on correctness of a classification result of the series data and time required for the classification; and
training the classifier based on the loss.

According to the present disclosure, it is possible to provide a machine learning model capable of obtaining an accurate classification result at an early stage of input series data.

### BRIEF DESCRIPTION OF THE DRAWINGS

FIG. 1 illustrates an overall configuration of a classification device;

FIG. 2 is a block diagram illustrating a hardware configuration of the classification device;

FIG. 3 is a block diagram illustrating a functional configuration of the classification device;

FIG. 4 is a flowchart of classification processing by the classification device;

FIG. 5 is a block diagram illustrating a functional configuration of a training device;

FIG. 6 is a block diagram illustrating a functional configuration of another classification device;

FIG. 7 is a block diagram illustrating a functional configuration of another training device;

FIG. 8 illustrates a schematic configuration of a gate control system to which the classification device is applied;

FIG. 9 is a block diagram illustrating a functional configuration of another training device; and

FIG. 10 is a flowchart of processing by another training device.

### EXAMPLE EMBODIMENTS

Hereinafter, preferred example embodiments of the present disclosure will be described with reference to the drawings.

### First Example Embodiment

### (Overall Configuration)

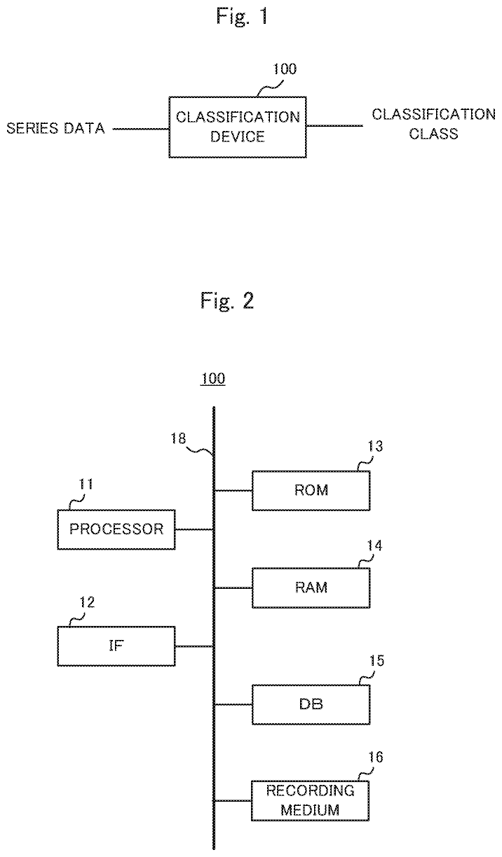

FIG. 1 illustrates an overall configuration of a classification device according to the present disclosure. A classification device 100 classifies input series data into any of a plurality of classes, and outputs a class (hereinafter, also referred to as a “classification class”) obtained as a classification result. The series data is data including a plurality of elements arranged in a predetermined order, and examples thereof include time-series data, for example. More specific examples of the series data include moving image data, audio data, and data obtained by subdividing image data, but are not limited thereto. The classification device 100 classifies each series data into any of the plurality of classes. The plurality of classes of classification may be two or three or more classes.

### (Hardware Configuration)

FIG. 2 is a block diagram illustrating a hardware configuration of the classification device 100. As illustrated, the classification device 100 includes a processor 11, an interface (IF) 12, a read only memory (ROM) 13, a random access memory (RAM) 14, a database (DB) 15, and a storage medium 16. The components are connected to one another via a bus 18, for example.

The processor 11 is a computer such as a central processing unit (CPU), and controls an entire classification device 100 by executing a program prepared in advance. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of them can be used.

The processor 11 loads the program stored in the ROM 13 or the storage medium 16 into the RAM 14 and executes each processing coded in the program. The processor 11 functions as a part of the classification device 100 or as an entire classification device 100. Specifically, the processor 11 executes classification processing and training of the classification device to be described later.

The IF 12 transmits and receives data to and from an external device. Specifically, when training, the classification device 100 receives training data through the IF 12. The training data includes the series data and a label indicating a correct answer of the classification result of the series data. When classifying, the classification device 100 receives the series data to be classified through the IF 12, and outputs the classification class to a storage device or the external device as the classification result.

The ROM 13 stores various programs to be executed by the processor 11. The RAM 14 is used as a working memory during execution of various types of processing by the processor 11.

The DB 15 stores various algorithms, data, a machine learning model, and a deep learning model used when the classification device 100 executes the classification processing to be described later and the training of the classification device 100 to be described later.

The storage medium 16 is a non-volatile and non-transitory storage medium, such as a disk-shaped recording medium and a semiconductor memory. The storage medium 16 may be detachably attached to the classification device 100. The storage medium 16 records various programs to be executed by the processor 11.

In addition to the description above, the classification device 100 may include a display device such as a liquid crystal display, and an input device such as a keyboard and a mouse. Such display device and input device are used, for example, by an operator of the classification device 100.

### (Classification Device)

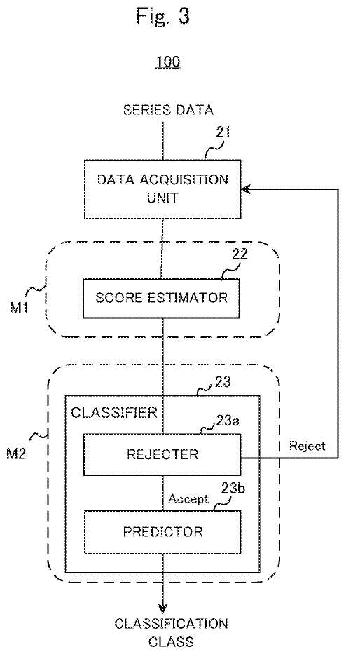

FIG. 3 is a block diagram illustrating a functional configuration of the classification device 100. The classification device 100 includes a data acquisition unit 21, a score estimator 22, and a classifier 23. The classifier 23 includes a rejecter 23a and a predictor 23b. The score estimator 22 is formed of one machine learning model M1. The classifier 23 is formed of a machine learning model M2 different from the machine learning model M1 forming the score estimator 22. The machine learning models M1 and M2 can be formed of, for example, a neural network (hereinafter, also referred to as “NN”), but are not limited thereto.

The series data including a plurality of elements is input to the data acquisition unit 21 as a classification target. The data acquisition unit 21 sequentially outputs the plurality of elements included in the series data to the score estimator 22.

The score estimator 22 estimates a score based on the input element. The score is a value indicating to which of the plurality of classes the series data belongs. As the score, for example, a likelihood ratio or a log-likelihood ratio (LLR) can be used.

The score estimator 22 estimates the score each time the element is acquired from the data acquisition unit 21. That is, the score estimator 22 estimates the score when acquiring one element from the data acquisition unit 21, and estimates a new score when acquiring a next element from the data acquisition unit 21. The score estimator 22 may estimate the score using one element acquired immediately before. The score estimator 22 may estimate the new score using not only one element acquired immediately before but also one or more elements acquired in the past or one or more scores estimated in the past (that is, the score estimated from the element acquired in the past). The score estimator 22 outputs the estimated score to the classifier 23.

The score estimated by the score estimator 22 is input to the rejecter 23a of the classifier 23. The rejecter 23a compares the input score with a predetermined threshold. The threshold is a reference value used to classify the series data into any of the plurality of classes, and is set in advance for each class. The rejecter 23a determines whether the input score is larger than a threshold related to any class. In a case where the input score is not larger than the threshold related to any class, this means that the series data cannot be classified yet into any class. Therefore, the rejecter 23a rejects the score and notifies the data acquisition unit 21 of the rejection. When the score for the first element is rejected, the data acquisition unit 21 outputs the next element in the series data to the score estimator 22. In this manner, the data acquisition unit 21 sequentially acquires the elements in the series data until the score larger than the threshold related to any class is obtained, and the score estimator 22 estimates the scores based on the elements.

In contrast, in a case where the input score is larger than the threshold related to any class, the rejecter 23a outputs the score to the predictor 23b. The predictor 23b classifies the series data into any class based on the score. For example, the predictor 23b classifies the series data into a class A in a case where the score exceeds a threshold related to the class A. The predictor 23b classifies the series data into a class B in a case where the score exceeds a threshold related to the class B. The predictor 23b outputs the classification class as the classification result.

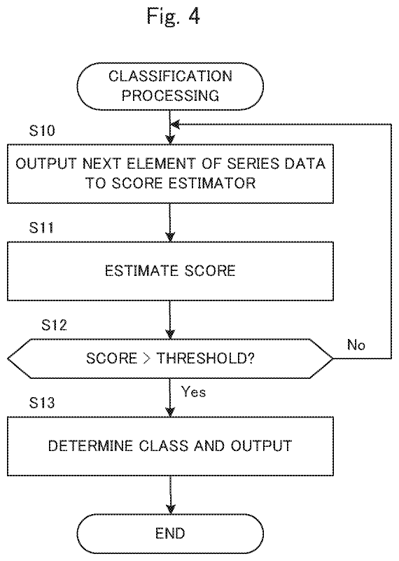

FIG. 4 is a flowchart of the classification processing by the classification device 100. This processing is achieved by the processor 11 illustrated in FIG. 2 executing the program prepared in advance and operating as the element illustrated in FIG. 3.

The data acquisition unit 21 first outputs the next element of the series data to the score estimator 22 (step S10). At the beginning of the classification processing, the data acquisition unit 21 outputs a first element of the series data. In a case where the series data is time-series data, the data acquisition unit 21 outputs an element at next time in the time-series data.

The score estimator 22 estimates the score of the series data based on the acquired element (step S11). The rejecter 23a next determines whether the estimated score is larger than the threshold related to any class of the classification (step S12). In a case where the score is not larger than the threshold (step S12: No), the procedure returns to step S10, and the data acquisition unit 21 outputs the next element in the same series data to the score estimator 22. The score estimator 22 estimates the score of the series data based on the acquired next element (step S11). In this manner, steps S10 to S12 are repeated until the score estimated by the score estimator 22 becomes larger than the threshold related to any class.

In contrast, in a case where the estimated score is larger than the threshold related to any class (step S12: Yes), the predictor 23b determines that the series data belongs to the class and outputs the class as the classification class (step S13). The classification processing ends.

### (Training Device)

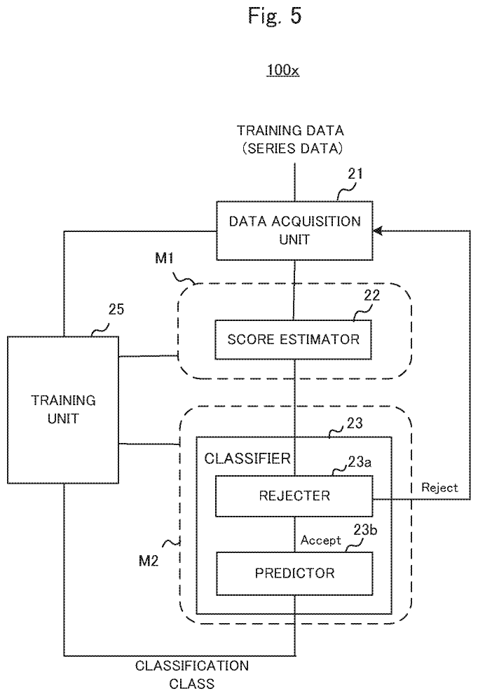

FIG. 5 is a block diagram illustrating a functional configuration of a training device 100x that trains the classification device 100. The training device 100x includes a training unit 25 in addition to the configuration of the classification device 100 illustrated in FIG. 3. The training data is input to the data acquisition unit 21. The training data includes a plurality of series data and a correct answer label indicating a class to which each series data belongs. The data acquisition unit 21 outputs the series data in the training data to the score estimator 22, and outputs the correct answer label in the training data to the training unit 25.

In the first example embodiment, the classification device 100 is trained in two stages. Specifically, the training unit 25 first trains the model M1 forming the score estimator 22 (referred to as “first training”), and then trains the model M2 forming the classifier 23 (referred to as “second training”).

In the first training, the data acquisition unit 21 acquires the series data in the training data and sequentially outputs elements included in the series data to the score estimator 22. The score estimator 22 estimates the score based on the input element and outputs the estimated score to the training unit 25. The training unit 25 optimizes the model M1 forming the score estimator 22 based on the input score and the correct answer label included in the training data. In the first training, the training unit 25 may optimize the score estimator 22 using, for example, a general loss function such as cross entropy. For example, in a case where the score estimator 22 is formed of the neural network, the training unit 25 optimizes parameters of the neural network forming the score estimator 22 in such a way as to minimize the loss calculated using the score and the correct answer label.

When the first training is completed, the second training is performed. In the second training, the trained score estimator 22 obtained by the first training is used. The data acquisition unit 21 acquires the series data in the training data and sequentially outputs the elements thereof to the score estimator 22. The score estimator 22 estimates the score based on the elements of the series data, and the classifier 23 compares the score with a threshold of each class. In a case where the score is not larger than the threshold of any class, the rejecter 23a rejects the score, and the score estimator 22 estimates a new score based on the next element. In contrast, in a case where the score is larger than the threshold related to any class, the predictor 23b outputs the class as the classification class of the series data to the training unit 25.

The training unit 25 calculates the loss based on the correct answer label included in the training data and the classification class input from the predictor 23b, and optimizes the classifier 23 (model M2) in such a way as to minimize the loss.

In the second training, the training unit 25 performs the training using a loss function based on correctness of the classification result of the series data and time required for classification. The “correctness of the classification result of the series data” indicates whether the classification result is correct, and is reflected in a classification error cost. The “time required for classification” indicates a speed of classification, and is reflected in a determination time delay cost of the classification class. That is, the loss function is intuitively expressed by the following expression (1).

(Loss function)=(classification error cost)+(determination time delay cost) (1)

Herein, the “classification error cost” is a cost that becomes large in a case where the classification class by the classifier 23 does not match the correct answer label. The “determination time delay cost” is a cost that becomes larger as the time (referred to as “determination time”) required from the input of the first element included in the series data to the determination of the classification class by the classifier 23 is longer. In this manner, by training the model M2 forming the classifier 23 using the loss function including the determination time delay cost in addition to the classification error cost, it is possible to obtain the classifier capable of classifying the series data at an early stage.

Specifically, a loss function L_{EC} used for the second training is expressed by the following expression (2).

$${L}_{EC} ( {S}_{t} , {d}_{t} ( {X}^{( 1 , t )} ) = k ) := {\underbrace{{L}_{k} ( 1 - {π}_{k} ( {X}^{( 1 , t )} ) )}}_{T 1} {\underbrace{+ ct}}_{T 2} \qquad ( 2 )$$

### (Definition)

Lₖ: cost added when classification is wrong (constant defined by user)
πₖ: probability that classifier classifies input series to class k
t: time
X^{(1,t)}: input series from time 1 to time t
c: cost for one step of determination time delay (constant defined by user)
Sₜ: estimated score (LLP)
dₜ=k: “assumption that classified class of predictor is k”

On a left side of expression (2), Sₜ represents a score estimated by the score estimator 22. X^{(1,t)} represents series data input from time 1 to time t, and dₜ(X^{(1,t)})=k indicates an assumption that the classification class of the predictor 23b is k. On a right side of expression (2), Lₖ represents a classification error cost, that is, a cost added when the classification is wrong, and is a constant defined by a user. “πₖ” represents a probability that the classifier 23 classifies the input series data into the class k. “t” represents time. “c” represents a determination time delay cost, which specifically is a cost for one step of determination time delay, and is a constant defined by the user. A first term T1 on the right side of expression (2) corresponds to “classification error cost” of expression (1). A second term T2 on the right side of expression (2) corresponds to “determination time delay cost” of expression (1).

The training unit 25 trains the classifier 23 in such a way as to minimize the loss L_{EC} in expression (2). By minimizing the loss L_{EC} in expression (2), the threshold in the classifier 23 can be optimized. For example, in a case where the classifier 23 is formed of the neural network, the training unit 25 optimizes parameters of the neural network forming the classifier 23 in such a way as to minimize the loss L_{EC} in expression (2). By minimizing the loss function in expression (2) for data in which a maximum length of the series data is determined without making an assumption on data distribution, it is possible to obtain the classification device 100 capable of classifying the time-series data at an early stage.

### Second Example Embodiment

Next, a classification device of a second example embodiment will be described. Since an overall configuration and a hardware configuration of a classification device 110 of the second example embodiment are similar to those in the first example embodiment, description thereof will be omitted. In the first example embodiment, as described above, the score estimator 22 is optimized by the first training, and then the classifier is optimized by the second training. However, when two-stage training is performed in this way, a calculation load in each training is large. Therefore, in the second example embodiment, the score estimator 22 and the classifier 23 are formed of one machine learning model, and they are simultaneously optimized using one loss function. Therefore, instead of using the loss function of expression (2) in the first example embodiment, a surrogate loss function to be described later is used.

### (Classification Device)

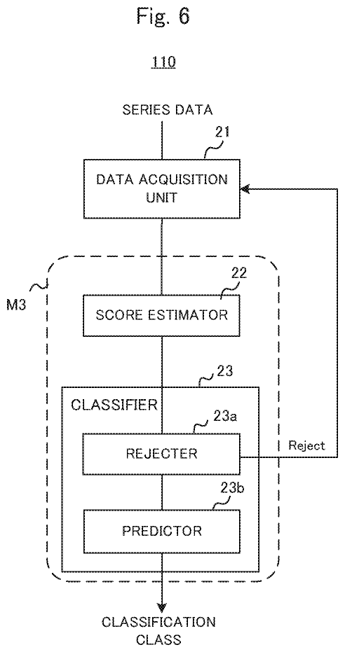

FIG. 6 is a block diagram illustrating a functional configuration of the classification device 110 according to the second example embodiment. As understood from comparison with FIG. 3, in the classification device 110 according to the second example embodiment, the score estimator 22 and the classifier 23 are formed of one machine learning model M3. As the machine learning model M3, for example, a neural network can be used. The configurations of the data acquisition unit 21, the score estimator 22, and the classifier 23 are similar to those of the classification device 100 of the first example embodiment. Classification processing by the classification device 110 of the second example embodiment is basically similar to that of the first example embodiment, and is achieved by the flowchart illustrated in FIG. 4. Therefore, the description is herein omitted.

### (Training Device)

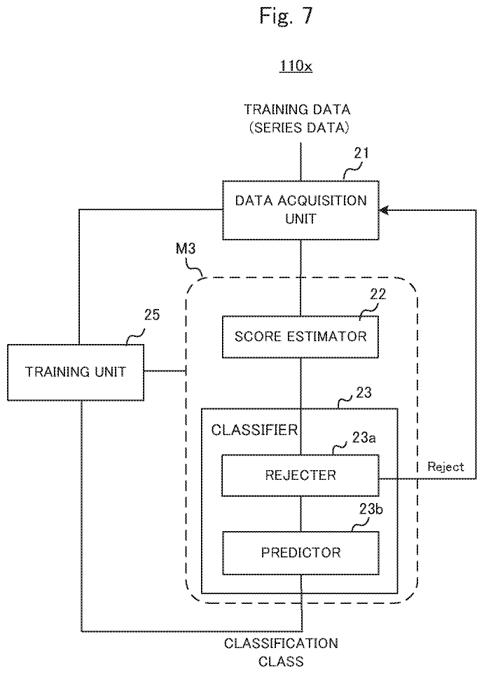

FIG. 7 is a block diagram illustrating a functional configuration of a training device 110x of the classification device 110. The configuration of the training device 110x is similar to that of the training device 100x illustrated in FIG. 5 except that the score estimator 22 and the classifier 23 are formed of one machine learning model M3 as described above. That is, in the second example embodiment, the training unit 25 simultaneously optimizes the model M3 including the score estimator 22 and the classifier 23 using the training data.

The surrogate loss function used for training by the training unit 25 is formed of “classification error cost” and “determination time delay cost” similarly to expression (1) described above. Hereinafter, two examples of the surrogate loss function used in the second example embodiment will be described.

### (1) First Surrogate Loss Function

A first surrogate loss function L_{CEC} is expressed by the following expression (3).

$${L}_{CEC} ( {h}^{( 1 , t )} , {x}^{( 1 , t )} , y ) := {\sum }_{t = 1}^{τ ( {x}^{( 1 , t )} )} c ( {x}^{( 1 , t )} , y ) Ψ ( \frac{{e}^{{h}_{y}^{( t )} ( {x}^{( 1 , t )} )}}{{\sum }_{k ∈ y} {e}^{{h}_{k}^{( t )} ( {x}^{( 1 , t )} )}} ) + ( 1 - c ( {x}^{( 1 , t )} , y ) ) Ψ ( \frac{{e}^{{h}_{y}^{( t )} ( {x}^{( 1 , t )} )} + {e}^{{h}_{K + 1}^{( t )} ( {x}^{( 1 , t )} )}}{{\sum }_{k ∈ y} {e}^{{h}_{k}^{( t )} ( {x}^{( 1 , t )} )}} ) \qquad ( 3 )$$

### (Definition)

$${h}^{( 1 , T )} = ( {h}_{1}^{( 1 )} , {h}_{1}^{( 2 )} , … , {h}_{1}^{( T )} , {h}_{2}^{( 1 )} , … , {h}_{K + 1}^{( 1 )} , … , {h}_{K + 1}^{( T )} )$$

score function
τ: determination time (substantially equivalent to

$${h}_{K + 1}^{( 1 , T )} ) ,$$

K: number of classes,
T: maximum length of input series,
X^{(1,T)}: input series,
y(∈Y:={1, 2, . . . , K}): class of input series,
Y̅={1, 2, . . . , K+1}: in extended class set, K+1 relates to reject (wait one more step),
c: cost for one step of determination time delay (constant defined by user), and
Ψ: non-decreasing function, for example Ψ(s)=−log (s).

In the loss function L_{CEC} in expression (3), “CEC” means consistent early classification loss. On a left side of the loss function L_{CEC}, h^{(1,T)} represents a score function used by the rejecter 23a and the predictor 23b of the classifier 23, and outputs a class of a maximum score. In an element h₁⁽¹⁾ of the score function h^{(1,T)}, a superscript “1” in lower right indicates a class, and a superscript “(1)” in upper right indicates time. A class “K+1” in the score function h^{(1,T)} represents a class indicating that the score estimated by the score estimator 22 is equal to or smaller than the threshold and the rejecter 23a rejects the score.

“x^{(1,T)}” is input series data (also referred to as an “input series”). “y” is a class of the input series, which corresponds to the correct answer label in the training data described above. Therefore, a left side of expression (3) indicates a loss in a case where the score estimated by the score estimator 22 is h^{(1,T)}, the input series is x^{(1,T)}, and the correct answer label of the input series is y.

On a right side of expression (3), “τ” represents determination time, and “K” represents the number of classes. “T” represents a maximum length of the input series data. “c” is a determination time delay cost. “Ψ” is a non-decreasing function. A class set including a class (K+1) indicating that the classification result is rejected is represented by Y⁻. For convenience of notation, “Y⁻” means a character Y with a bar (−) added above the same.

When expression (3) is divided into a term including the determination time delay cost c and a term not including the determination time delay cost c, expression (4) is obtained.

$${L}_{CEC} ( {h}^{( 1 , T )} , {x}^{( 1 , T )} , y ) = {\sum }_{t = 1}^{τ ( {x}^{( 1 , τ )} )} {\underbrace{Ψ ( \frac{{e}^{{h}_{y}^{( t )} ( {x}^{( 1 , t )} )} + {e}^{{h}_{K + 1}^{( t )} ( {x}^{( 1 , t )} )}}{{\sum }_{k ∈ \overline{Y}} {e}^{{h}_{k}^{( t )} ( {x}^{( 1 , t )} )}} )}}_{T 3} + {\underbrace{c ( {x}^{( 1 , t )} , y ) ( Ψ ( \frac{{e}^{{h}_{y}^{( t )} ( {x}^{( 1 , t )} )}}{{\sum }_{k ∈ \overline{Y}} {e}^{{h}_{k}^{( t )} ( {x}^{( 1 , t )} )}} ) - Ψ ( \frac{{e}^{{h}_{y}^{( t )} ( {x}^{( 1 , t )} )} + {e}^{{h}_{K + 1}^{( t )} ( {x}^{( 1 , t )} )}}{{\sum }_{k ∈ \overline{Y}} {e}^{{h}_{k}^{( t )} ( {x}^{( 1 , t )} )}} ) )}}_{T 4} \qquad ( 4 )$$

A term T3 on a right side of expression (4) corresponds to “classification error cost” of expression (1), and a term T4 corresponds to “determination time delay cost” of expression (1).

The training unit 25 trains the score function h^{(1,T)} by a machine learning model such as a deep neural network (hereinafter, also referred to as “DNN”) using the surrogate loss function in expression (3). The score function h^{(1,T)} that minimizes the surrogate loss function in expression (3) also has a property of minimizing the loss function in expression (2) in the first example embodiment. This is proven as follows.

<Proof> The loss L_{CEC} has realizable H-consistency.

It is assumed that H is closed under scaling, Y is monotonically non-increasing, and Ψ(2/3) is positive; and

lim_{s→1}Ψ(s)=0

At that time, the loss L_{CEC} has realizable H-consistency regarding the loss L_{EC} of expression (2). That is, by minimizing the loss L_{CEC} for any distribution where there is a predictor h*∈H that achieves zero ECL

ε_{L}_{_{EC}}(h*)=0
a zero error solution is also obtained:

ĥ^{(1,T)}∈argmin ε_{L}_{_{CEC}}⇒ε_{L}_{_{EC}}(h^{(1,T)})=0h^{(1,T)}∈H

### (2) Second Surrogate Loss Function

A second surrogate loss function L_{CEC2} is expressed by the following expression (5).

$${L}_{CEC 2} ( {h}^{( 1 , T )} , {r}^{( 1 , T )} , {x}^{( 1 , T )} , y ) = {{\sum }_{t = 1}}^{τ ( {r}^{( 1 , T )} , {x}^{( 1 , T )} )} [ {\underbrace{l ( {h}^{( t )} , {x}^{( 1 , t )} , y ) Φ ( - α {r}^{( t )} )}}_{T 5} + {\underbrace{c Φ ( α {r}^{( t )} )}}_{T 6} ] \qquad ( 5 )$$

In expression (5), l(h^{(t)},x^{(1,t)},y) represents a surrogate loss with

1ₕ_{^{(t)}}_{≠y}
as an upper limit, and Φ represents a surrogate loss with

x→1_{x≤0}
as an upper limit. “α” is a positive constant. An average absolute error with respect to 1 is

$${l}_{mae} ( {h}^{( t )} , {x}^{( 1 , t )} , y ) := 1 - {s}^{( t )} ( {h}^{( t )} , {x}^{( 1 , T )} , y ) ,$$

$${s}^{( t )} ( {h}^{( t )} , {x}^{( 1 , T )} , y ) = \frac{exp ( {h}^{( t )} ( {x}^{( 1 , t )} ) , y )}{{\sum }_{{y}^{′} ∈ 𝒴} exp ( {h}^{( t )} ( {x}^{( 1 , t )} ) , {y}^{′} )}$$

and an exponent loss is

Φ(t)=exp(−t)

Unlike the first surrogate loss function L_{CEC}, in expression (5), the score function h^{(1,T)} represents a score function of 1 to K classes, and a score function r^{(1,T)} of a (K+1) class of the rejecter 23a is provided separately from the score function h^{(1,T)}. Except for this point, variables and constants in the second surrogate loss function L_{CEC2} are similar to those of the first surrogate loss function L_{CEC}.

A first term T5 on a right side of expression (5) corresponds to “classification error cost” of expression (1), and a second term T6 corresponds to “determination time delay cost” of expression (1).

The training unit 25 trains the score functions h^{(1,T)} and r^{(1,T)} by the machine learning model such as the DNN using the surrogate loss function in expression (5). The score functions h^{(1,T)} and r^{(1,T)} that minimize the surrogate loss function in expression (5) also have a property of minimizing the loss function L_{EC} in expression (2) in the first example embodiment. This is proven as follows.

<Proof> The loss L_{CEC2} has realizable (H,R) consistency.

The fact that the surrogate loss function L_{CEC2} has (H,R)-consistency with respect to two hypothesis classes H, R and loss L_{EC} means that there is a non-decreasing function that is continuous at 0

f: [symbol] _{≤0}→ [symbol] _{≥0},

and the following inequality holds for any predictor h^{(1,T)}∈H and rejecter r^{(1,T)}∈R:

$${ℰ}_{{L}_{EC}} ( {h}^{( 1 , T )} , {r}^{( 1 , T )} ) - {ℰ}_{{L}_{EC}}^{*} ( ℋ , ℛ ) + {ℳ}_{{L}_{EC}} ( ℋ , ℛ ) \leq f ( {ℰ}_{L} ( {h}^{( 1 , T )} , {r}^{( 1 , T )} ) - {ℰ}_{L}^{*} ( ℋ , ℛ ) + {ℳ}_{L} ( ℋ , ℛ ) )$$

Here, the following is defined for any loss function L:

$${ℰ}_{L} ( {h}^{( 1 , T )} , {r}^{( 1 , T )} ) = {𝔼}_{{x}^{( 1 , T )} , y} [ L ( {h}^{( 1 , T )} , {r}^{( 1 , T )} , {x}^{( 1 , T )} , y ) ] ,$$

$${ℰ}_{L}^{*} ( ℋ , ℛ ) = {inf}_{{h}^{( 1 , T )} ∈ ℋ , {r}^{( 1 , T )} ∈ ℛ} {𝔼}_{{x}^{( 1 , T )} , y} [ L ( {h}^{( 1 , T )} , {r}^{( 1 , T )} , {x}^{( 1 , T )} , y ) ]$$

$${ℳ}_{L} ( ℋ , ℛ ) = {ℰ}_{L}^{*} ( ℋ , ℛ ) - {𝔼}_{{x}^{( 1 , T )}} [ {inf}_{{h}^{( 1 , T )} ∈ ℛ , {r}^{( 1 , T )} ∈ ℛ} {𝔼}_{y \vert {x}^{( 1 , T )}} [ L ( {h}^{( 1 , T )} , {r}^{( 1 , T )} , {x}^{( 1 , T )} , y ) ] ]$$

As described above, in the second example embodiment, the classifier that minimizes the loss function L_{EC} of the first example embodiment can be obtained only by one training that minimizes the first surrogate loss function L_{CEC} or the second surrogate loss function L_{CEC2.}

### Application Example

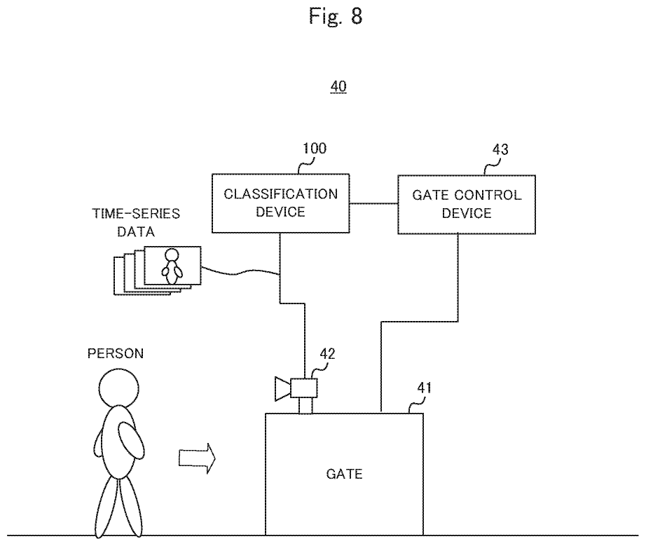

Next, an application example of the classification device of the present disclosure will be described. The classification device 100 can be applied to face authentication using time-series data such as camera images as an input. FIG. 8 illustrates a schematic configuration of a gate control system to which the classification device 100 is applied. The gate control system 40 includes a gate 41, a camera 42, a gate control device 43, and the classification device 100. The gate control system 40 performs face authentication of a person who tries to enter a building, and opens the gate 41 to allow the person who has succeeded in the authentication to enter.

Specifically, the camera 42 provided at the gate 41 captures a moving image of a person approaching the gate and outputs the moving image to the classification device 100. The moving image captured by the camera 42 is input to the classification device 100 as time-series data. The classification device 100 performs face authentication of a person based on the time-series data. For example, the classification device 100 classifies the face of the person indicated by the time-series data into either a real face or a fake face, and outputs a classification result to the gate control device 43. Note that the real face is an actual human face. The fake face means, for example, a case where a certain person tries to intrude wearing a face mask or using a terminal displaying a photograph or an image of another person's face. In a case where the face of the person is the real face, the gate control device 43 transmits a control signal to the gate 41 to open the gate 41.

In the gate control system 40, it is desirable that the face of the person can be classified as early as possible for the reason of avoiding congestion at the gate. In this regard, according to the classification device 100 of the present disclosure, as described above, since the classifier 23 is trained using the loss function in consideration of the determination time delay cost, the face of the person approaching the gate 41 can be classified at an early stage. In this example, the classification device 100 classifies the real face and the fake face, but the class to be classified is not limited thereto.

### Third Example Embodiment

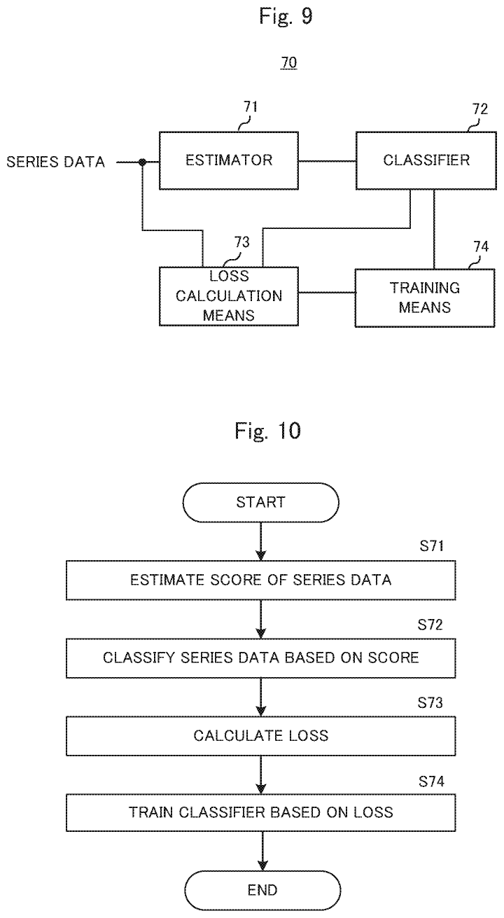

FIG. 9 is a block diagram illustrating a functional configuration of a training device of a third example embodiment. A training device 70 includes an estimator 71, a classifier 72, a loss calculation means 73, and a training means 74.

FIG. 10 is a flowchart of processing by the training device of the third example embodiment. The estimator 71 sequentially acquires a plurality of elements included in series data and estimates a score of the series data for a plurality of classes of classification (step S71). The classifier 72 classifies the series data into any of the plurality of classes based on the score (step S72). The loss calculation means 73 calculates a loss using a loss function based on correctness of a classification result of the series data and time required for classification (step S73). The training means 74 trains the classifier based on the loss (step S74).

According to the training device 70 of the third example embodiment, it is possible to provide the classification device capable of obtaining an accurate classification result at an early stage of the input series data.

A part or all of the example embodiments described above may also be described as the following supplementary notes, but not limited thereto.

### (Supplementary Note 1)

A training device comprising:
an estimator that sequentially acquires a plurality of elements included in series data and estimates a score of the series data for a plurality of classes of classification;
a classifier that classifies the series data into any of the plurality of classes based on the score;
a loss calculation means for calculating a loss using a loss function based on correctness of a classification result of the series data and time required for the classification; and
a training means for training the classifier based on the loss.

### (Supplementary Note 2)

The training device according to Supplementary note 1,
wherein the time required for the classification is time from when a first element of the plurality of elements is acquired to when the classification result is obtained, and
wherein a value of the loss becomes larger as the time required for the classification is longer.

### (Supplementary Note 3)

The training device according to Supplementary note 1, wherein the classifier classifies the series data based on the score in a case where the score is larger than a predetermined threshold, rejects the score in a case where the score is smaller than the predetermined threshold, and classifies the series data based on a score estimated based on a next element in the series data.

### (Supplementary Note 4)

The training device according to Supplementary note 1, wherein the loss function is expressed by following expression (6)

L_{EC}(Sₜ,dₜ(X^{(1,t)})=k):=Lₖ(1−πₖ(X^{(1,t)}))+ct (6),

wherein

Lₖ represents a cost added when classification is wrong;

πₖ represents a probability that the classifier classifies the input series data to a class k,
t represents time,
X^{(1,t)} represents the series data input from time 1 to time t,
c represents a cost for a delay in time required for the classification,
Sₜ represents the score, and
dₜ represents a class classified by the classifier.

### (Supplementary Note 5)

The training device according to Supplementary note 1, wherein the training means trains the estimator by using training data, and trains the classifier by using a trained estimator.

### (Supplementary Note 6)

The training device according to Supplementary note 1, wherein the loss function is expressed by following expression (7)

$${L}_{CEC} ( {h}^{( 1 , T )} , {x}^{( 1 , T )} , y ) := {\sum }_{t = 1}^{τ ( {x}^{( 1 , τ )} )} c ( {x}^{( 1 , t )} , y ) Ψ ( \frac{{e}^{{h}_{y}^{( t )} ( {x}^{( 1 , t )} )}}{{\sum }_{k ∈ \overline{𝒴}} {e}^{{h}_{k}^{( t )} ( {x}^{( 1 , t )} )}} ) + ( 1 - c ( {x}^{( 1 , t )} , y ) ) Ψ ( \frac{{e}^{{h}_{y}^{( t )} ( {x}^{( 1 , t )} )} + {e}^{{h}_{K + 1}^{( t )} ( {x}^{( 1 , t )} )}}{{\sum }_{k ∈ \overline{𝒴}} {e}^{{h}_{k}^{( t )} ( {x}^{( 1 , t )} )}} ) , \qquad ( 7 )$$

h^{(1,T)} represents a score function expressed by following expression (8)

$${h}^{( 1 , T )} = ( {h}_{1}^{( 1 )} , {h}_{1}^{( 2 )} , … , {h}_{1}^{( T )} , {h}_{2}^{( 1 )} , … , {h}_{K + 1}^{( 1 )} , … , {h}_{K + 1}^{( T )} ) , \qquad ( 8 )$$

wherein
t represents time,
τ represents time required for the classification,
K represents the number of the classes,
T represents a maximum length of the series data,
x^{(1,t)} represents the series data,
y represents a class of the series data,
Y⁻ represents a class set including a class (K+1) indicating that the classification result is rejected,
c represents a cost for a delay in time required for the classification, and
Ψ represents a non-decreasing function.

### (Supplementary Note 7)

The training device according to Supplementary note 1, wherein the loss function is expressed by following expression (9)

$${L}_{CEC 2} ( {h}^{( 1 , T )} , {r}^{( 1 , T )} , {x}^{( 1 , T )} , y ) = {{\sum }_{t = 1}}^{τ ( {r}^{( 1 , T )} , {x}^{( 1 , T )} )} [ l ( {h}^{( t )} , {x}^{( 1 , t )} , y ) Φ ( - α {r}^{( t )} ) + c Φ ( α {r}^{( t )} ) ] , \qquad ( 9 )$$

h^{(1,T)} represents a score function expressed by following expression (8)

$${h}^{( 1 , T )} = ( {h}_{1}^{( 1 )} , {h}_{1}^{( 2 )} , … , {h}_{1}^{( T )} , {h}_{2}^{( 1 )} , … , {h}_{K + 1}^{( 1 )} , … , {h}_{K + 1}^{( T )} ) , \qquad ( 8 )$$

wherein
r^{(1,T)} represents a score function of a class (K+1) indicating that the classification result is rejected,
t represents time,
τ represents time required for the classification,
T represents a maximum length of the series data,
x^{(1,t)} represents the series data,
y represents a class of the series data,
c represents a cost for a delay in time required for the classification,
l(h^{(t)},x^{(l,t)},y) and Φ represent surrogate losses, and
α represents a positive constant.

### (Supplementary Note 8)

The training device according to Supplementary note 6, wherein the training means simultaneously trains the estimator and the classifier.

### (Supplementary Note 9)

A training method executed by a computer, the method comprising:
sequentially acquiring a plurality of elements included in series data, and estimating a score of the series data for a plurality of classes of classification using an estimator;
classifying the series data into any of the plurality of classes based on the score using a classifier;
calculating a loss using a loss function based on correctness of a classification result of the series data and time required for the classification; and
training the classifier based on the loss.

### (Supplementary Note 10)

A program that causes a computer to execute processing of:
sequentially acquiring a plurality of elements included in series data, and estimating a score of the series data for a plurality of classes of classification using an estimator;
classifying the series data into any of the plurality of classes based on the score using a classifier;
calculating a loss using a loss function based on correctness of a classification result of the series data and time required for the classification; and
training the classifier based on the loss.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

11 Processor
21 Data acquisition unit
22 Score estimator
23 Classifier
23a Rejector
23b Predictor
25 Training unit
40 Gate control system
41 Gate
42 Camera
43 Gate control device
100, 110 Classification device
100x, 110x Training device

1. A training device comprising:
a memory configured to store instructions; and
one or more processors configured to execute the instructions to:
sequentially acquire a plurality of elements included in series data and estimate a score of the series data for a plurality of classes of classification using an estimator;
classify the series data into any of the plurality of classes based on the score using a classifier;
calculate a loss using a loss function based on correctness of a classification result of the series data and time required for the classification; and
train the classifier based on the loss.

2. The training device according to claim 1,
wherein the time required for the classification is time from when a first element of the plurality of elements is acquired to when the classification result is obtained, and
wherein a value of the loss becomes larger as the time required for the classification is longer.

3. The training device according to claim 1,
wherein the one or more processors classify the series data based on the score in a case where the score is larger than a predetermined threshold preset corresponding to any one of the classes, reject the score in a case where the score is not larger than any of the predetermined thresholds, and classify the series data based on a score estimated based on a next element in the series data, and
wherein the one or more processors acquire the next element in response to rejecting the score, repeat estimating the score based on the next element and comparing the score with the predetermined thresholds, output a classification result in a case where the score is larger than the predetermined threshold, and stop acquiring remaining elements of the series data after outputting the classification result.

4. The training device according to claim 1,
wherein the loss function is expressed by following expression (6)
L_{EC}(Sₜ,dₜ(X^{(1,t)})=k):=Lₖ(1−πₖ(X^{(1,t)}))+ct (6),
wherein
Lₖ represents a cost added when classification is wrong;
πₖ represents a probability that the classifier classifies the input series data to a class k,
t represents time,
X^{(1,t)} represents the series data input from time 1 to time t,
c represents a cost for a delay in time required for the classification,
Sₜ represents the score, and
dₜ represents a class classified by the classifier.

5. The training device according to claim 1, wherein the one or more processors train the estimator by using training data, and train the classifier by using a trained estimator.

6. The training device according to claim 1, wherein the loss function is expressed by following expression (7)
$${L}_{CEC} ( {h}^{( 1 , T )} , {x}^{( 1 , T )} , y ) := {\sum }_{t = 1}^{τ ( {x}^{( 1 , τ )} )} c ( {x}^{( 1 , t )} , y ) Ψ ( \frac{{e}^{{h}_{y}^{( t )} ( {x}^{( 1 , t )} )}}{{\sum }_{k ∈ \overline{𝒴}} {e}^{{h}_{k}^{( t )} ( {x}^{( 1 , t )} )}} ) + ( 1 - c ( {x}^{( 1 , t )} , y ) ) Ψ ( \frac{{e}^{{h}_{y}^{( t )} ( {x}^{( 1 , t )} )} + {e}^{{h}_{K + 1}^{( t )} ( {x}^{( 1 , t )} )}}{{\sum }_{k ∈ \overline{𝒴}} {e}^{{h}_{k}^{( t )} ( {x}^{( 1 , t )} )}} ) , \qquad ( 7 )$$
h^{(1,T)} represents a score function expressed by following expression (8)
$${h}^{( 1 , T )} = ( {h}_{1}^{( 1 )} , {h}_{1}^{( 2 )} , … , {h}_{1}^{( T )} , {h}_{2}^{( 1 )} , … , {h}_{K + 1}^{( 1 )} , … , {h}_{K + 1}^{( T )} ) , \qquad ( 8 )$$
wherein
t represents time,
τ represents time required for the classification,
K represents the number of the classes,
T represents a maximum length of the series data,
x^{(1,t)} represents the series data,
y represents a class of the series data,
Y⁻ represents a class set including a class (K+1) indicating that the classification result is rejected,
c represents a cost for a delay in time required for the classification, and
Ψ represents a non-decreasing function.

7. The training device according to claim 1, wherein the loss function is expressed by following expression (9)
$${L}_{CEC 2} ( {h}^{( 1 , T )} , {r}^{( 1 , T )} , {x}^{( 1 , T )} , y ) = {{\sum }_{t = 1}}^{τ ( {r}^{( 1 , T )} , {x}^{( 1 , T )} )} [ l ( {h}^{( t )} , {x}^{( 1 , t )} , y ) Φ ( - α {r}^{( t )} ) + c Φ ( α {r}^{( t )} ) ] , \qquad ( 9 )$$
h^{(1,T)} represents a score function expressed by following expression (8)
$${h}^{( 1 , T )} = ( {h}_{1}^{( 1 )} , {h}_{1}^{( 2 )} , … , {h}_{1}^{( T )} , {h}_{2}^{( 1 )} , … , {h}_{K + 1}^{( 1 )} , … , {h}_{K + 1}^{( T )} ) , \qquad ( 8 )$$
wherein
r^{(1,T)} represents a score function of a class (K+1) indicating that the classification result is rejected,
t represents time,
τ represents time required for the classification,
T represents a maximum length of the series data,
x^{(1,t)} represents the series data,
y represents a class of the series data,
c represents a cost for a delay in time required for the classification,
l(h^{(t)},x^{(1,t)},y) and Φ represent surrogate losses, and
α represents a positive constant.

8. The training device according to claim 6, wherein the one or more processors simultaneously train the estimator and the classifier.

9. A training method executed by a computer, comprising:
sequentially acquiring a plurality of elements included in series data, and estimating a score of the series data for a plurality of classes of classification using an estimator;
classifying the series data into any of the plurality of classes based on the score using a classifier;
calculating a loss using a loss function based on correctness of a classification result of the series data and time required for the classification; and
training the classifier based on the loss.

10. A non-transitory computer-readable storage medium storing a program, the program causing a computer to execute processing of:
sequentially acquiring a plurality of elements included in series data, and estimating a score of the series data for a plurality of classes of classification using an estimator;
classifying the series data into any of the plurality of classes based on the score using a classifier;
calculating a loss using a loss function based on correctness of a classification result of the series data and time required for the classification; and
training the classifier based on the loss.
